(19) United States
(12) Patent Application Publication
(10) Pub. No.: US 2022/0063222 A1
(43) Pub. Date: Mar. 3, 2022

(54) TIRE WITH COMPOSITE SEALANT LAYER AND METHOD OF MAKING

(71) Applicant: The Goodyear Tire & Rubber Company, Akron, OH (US)

(72) Inventors: Christopher David Dyrlund, Canton, OH (US); Adam Mark Baldan, Akron, OH (US); Elizabeth Amelia RogenskiMitchell, Atwater, OH (US)

(21) Appl. No.: 17/007,244

(22) Filed: Aug. 31, 2020

(51) Int. Cl. B29D 30/06

(52) U.S. Cl. CPC B29D 30/0685; B29D 2030/0694

(57) ABSTRACT

A method for forming a tire having a composite innerliner is described wherein the method includes the following steps: forming a coextruded strip of a first compound and a second compound, wherein the first compound may be an air impermeable compound, and the second compound is a cross linkable diene rubber compound, winding the coextruded strip onto a tire building drum while varying the ratio of the first compound to the second compound to form an inner liner layer of spirally wound coextruded strips.

### FIELD OF THE INVENTION

The invention relates in general to tire construction and tire manufacturing, and more particularly to a tire have a built in sealant layer and improved method of construction.

### BACKGROUND OF THE INVENTION

Tire manufacturers have progressed to more complicated designs due to an advance in technology as well as a highly competitive industrial environment. In particular, tire designers seek to use multiple rubber compounds in a tire component such as the tread in order to meet customer demands. In order to improve manufacturing efficiency, strip lamination of a continuous strip of rubber is often used to build a tire or tire component.

One tire component of interest to improve is the tire innerliner, which functions to prevent air loss from the tire. Rubbers such as butyl or halobutyl rubber are often used as a major portion of the innerliners. One problem that occurs when strip laminating the tire innerliner is low adhesion of the strip to the adjacent ply layer. Poor adhesion between the inner liner and ply can result in tire defects, resulting in the need to scrap the tire. Increasing the stitcher pressure to ensure adhesion does not solve the problem. Also, using a lower butyl rubber formulation to enhance adhesion typically results in a heavier liner, increasing the weight of the tire.

One tire component of interest to improve is a sealant layer typically applied on the inside of the tire. Post-cure applied sealant application is a complex and expensive process. The problem with a post cure applied sealant layer is that the sealant is subject to cold flow due to centrifugal forces, resulting in noticeable ride harshness after periods of rest. Thus, it is desired to have an improved tire having a layer of sealant that is formed such that it does not migrate after application.

Thus, an improved tire construction and method of making is desired which overcomes the aforementioned disadvantages. Furthermore, an in-line, pre-cure sealant application process via strip lamination is desired to decrease the complexity and cost of applying sealant to the tire. Since the sealant material provides a layer of air permeation resistance, it is also desired to combine the sealant and innerliner components into a single component to reduce tire weight and complexity while maintaining air retention and sealability performance.

### SUMMARY OF THE INVENTION

The invention provides in a first aspect a method for forming a tire having a composite layer, wherein the composite layer is located radially inward of the ply, wherein the method of forming the composite layer comprises the following steps: forming a dual layer strip of a first compound and a second compound, wherein the first compound is an air impermeable compound; and the second compound is a sealant compound, and then winding the dual layer strip onto a tire building drum.

The invention provides a second aspect of the invention of a tire having a composite layer, wherein the composite layer is located radially inward of a layer of ply, wherein the composite layer has a first and second laterally outer end that is formed of a strip of an air impermeable compound, and the composite layer has a middle portion formed of a dual layer strip having a radially inner layer of a sealant compound, and a radially outer layer formed of an air impermeable compound.

### DEFINITIONS

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a cross-sectional view of one half of a tire of the present invention;

FIG. 2 is a front perspective view of a dual compound strip;

FIG. 3A is a cross-sectional schematic of a composite inner liner and sealant layer of the present invention, while FIG. 3B is a photograph of an actual tire component formed from dual layer strips comprised of an inner liner and sealant compound;

FIG. 4 is a schematic layup of tire components with a composite inner liner and sealant layer of the present invention;

FIG. 5A is a front view of a dual strip forming apparatus, while FIG. 5B is a close-up view of a nozzle that forms the dual strip; and

FIG. 6 illustrates a spirally wound composite liner being formed on a tire building drum.

### DETAILED DESCRIPTION OF THE INVENTION

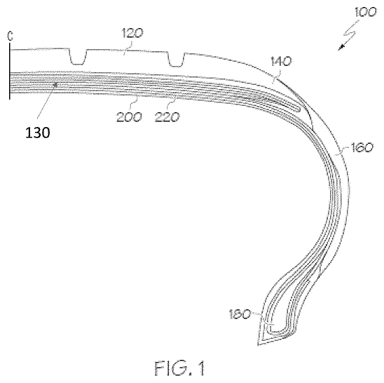

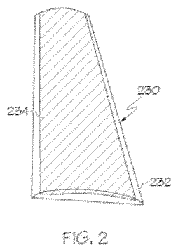

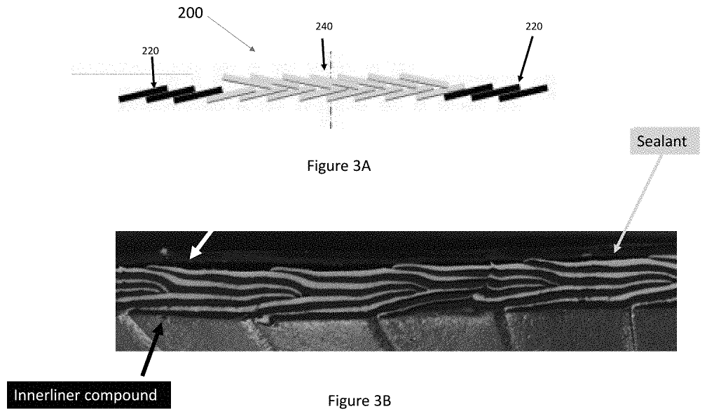

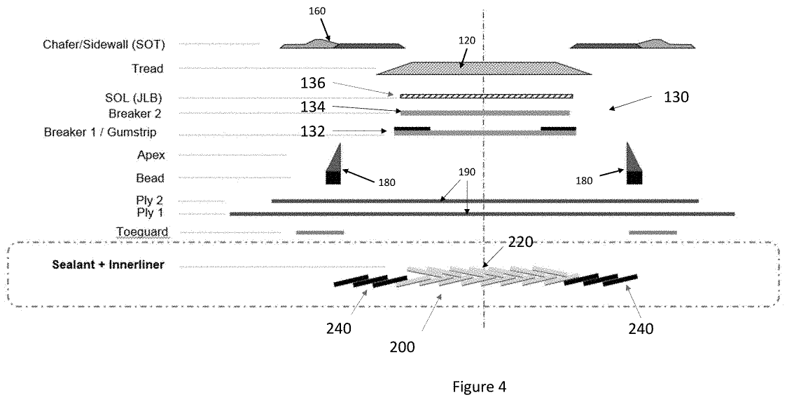

FIG. 1 illustrates one half of a pneumatic radial tire 100 of the present invention. The tire as shown is a passenger tire, but the invention as described herein is not limited to a passenger tire and may be used for other types of tires such as truck or OTR tires. As shown in FIG. 4, the tire is a conventional tire, and has a ground-engaging tread 120 and a belt package 130 formed of a first breaker 132, a second breaker 134 and a spiral overlay layer 134. The tire further includes a chafer and sidewall subassembly 160 that extend radially inwards from the shoulders 140 and terminates in a pair of bead portions 180. The tire 100 has a one or more layers of ply 190 that are anchored in a respective bead portion having an apex and bead subassembly 180. As shown in FIG. 3a, 3b and FIG. 4, a composite layer 200 of the present invention is located radially inward of the ply layer. The composite layer 200 is formed from a continuous dual layer strip 230, as shown in FIG. 2.

The dual layer strip 230 is formed of a first discrete layer 232 of a first compound that is joined to a discrete second layer 234 formed of a second compound. The first and second compounds are not mixed together to form the dual layer strip 230, and are only joined together at an interface. The first compound 232 is preferably formed of an air impermeable material such as butyl, bromobutyl, and halobutyl rubber as well as any material with the air permeability characteristics of butyl, bromobutyl, or halobutyl rubber. The second compound is preferably a sealant compound derived from a depolymerization of a butyl rubber-based sealant precursor composition, typically containing a rubber reinforcing carbon black filler to render the sealant black in color or containing precipitated silica with only a minimal amount of carbon black, if any, or exclusive of carbon black, together with a colorant to color the sealant layer a color other than black, preferably yellow, or alternatively, a partially organoperoxide-depolymerized butyl rubber as a copolymer of isobutylene and isoprene, wherein said copolymer prior to such depolymerization contains from about 0.5 to about 5 percent units derived from isoprene, and correspondingly from about 95 to about 99.5 weight percent units derived from isobutylene

Other suitable sealant compounds are known to those skilled in the art. For example, see U.S. Pat. Nos. 4,895,610, 4,228,839, 4,171,237, 4,140,167, 8,156,979, and 8,293,049 and U.S. Patent Publication Nos. 2003/0230376, 2004/0159386, 2005/0205186, and 2008/0115872.

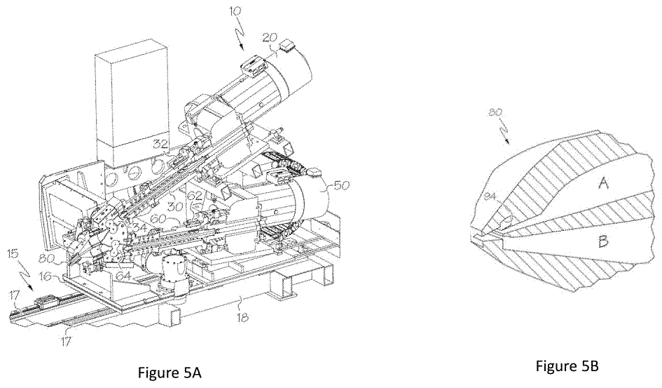

The dual extruder apparatus 10 as shown in FIGS. 5A and 5B is used to form a continuous dual layer strip 230. The dual extruder apparatus 10 includes a first extruder 30 in fluid communication with a first gear pump 34 for extruding the sealant compound and controlling the amount of the sealant compound with volumetric precision in order to form the top layer 234 of the dual strip 230. The dual extruder apparatus 10 further includes a second extruder 60 in fluid communication with a second gear pump 64 for extruding the inner liner compound with volumetric precision to form the bottom layer 232 of the dual strip 230.

The first and second gear pumps 34,64 are preferably placed in close proximity to each other so that the outlet channels of the first and second gear pumps are also in close proximity, as shown in FIG. 5A. The outlet channels are fed into a nozzle 80 which forms the dual layer strip 230. The width of the dual rubber strip output from the nozzle orifice is typically about 15 mm in width, but may vary in the range of about 3 mm to about 30 mm.

The dual extruder apparatus 10 may be used to vary in real time the ratio of the sealant compound to the inner liner compound by varying the ratio of the first gear pump speed to the second gear pump speed. By changing this ratio, the thickness and amount of the sealant compound relative to the thickness and amount of inner liner compound thickness will vary.

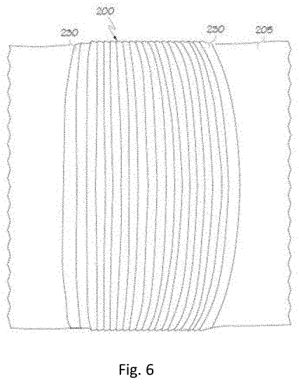

FIG. 3A illustrates a composite layer 200 of the present invention. The composite layer 200 is preferably located radially inward of the ply 190, as shown in FIG. 4. The composite layer 200 is formed by spirally winding a dual layer strip 230 onto a rotating tire building drum, as shown in FIG. 6. As shown in FIG. 3A, the composition of the dual layer strip is varied. On the axially outer ends 220 of the composite layer 200, the strip is at least 80% inner liner or air impermeable compound, and may vary in the range of 70%-100% inner liner or air impermeable compound. There is preferably a single layer of strip at the axially outer ends.

In the midportion 240 of the composite layer, the dual layer strip composition is in the range of 30-70% sealant and 70%-30% inner liner. Preferably, the dual layer strip composition is a 50%-50% ratio of sealant to inner liner. As shown in FIG. 4, there are two layers of spirally wound dual strips. The inner liner or air impermeable layer of each strip is oriented to be radially inward of the sealant layer.

The thickness of the inner liner layer 232 of the dual layer strip 230 is preferably in the range of about 0.3 mm to about 2 mm, and more preferably in the range of about 0.6 to about 1.2 mm. The thickness of the sealant layer 234 is preferably in the range of 3 to 6 mm and more preferably in the range of 3.5 to 5 mm. The overall width of the strip 230 is in the range of about 10 mm to about 50 mm, more preferably 20-25 mm.

In this invention, multiple strips of co-extruded innerliner and sealant are applied to the building drum, followed by application of body ply. The multiple layering provides a greater number of smaller sealant pockets. By encapsulating small pockets of sealant with innerliner compound, the invention greatly reduces the problem of cold flow. The invention also has the benefit of improved sealing via multiple layers of sealant and efficiencies gained by applying innerliner with sealant as single component, and ability to reduce innerliner gauge by coextruding with sealant compound. Furthermore, by building this component with the dual extruder apparatus, the composite sealant layer can be built in-line of the tire assembly process, before the tire is cured.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention.

What is claimed is:

1. A method for forming a tire having a composite layer, wherein the composite layer is located radially inward of the ply, wherein the method of forming the composite layer comprises the following steps:
forming a dual layer strip of a first compound and a second compound, wherein the first compound is an air impermeable compound; and the second compound is a sealant compound,
and then winding the dual layer strip onto a tire building drum.

2. The method of claim 1 wherein the ratio of the air impermeable compound to the sealant compound is varied.

3. The method of claim 1 wherein the air impermeable compound is oriented to be radially inward of the sealant compound.

4. The method of claim 1 wherein the air impermeable compound is butyl rubber or mixtures thereof.

5. The method of claim 1 wherein the sealant compound is derived from a depolymerization of a butyl rubber-based sealant precursor thereof.

6. The method of claim 1 wherein the dual strip forming the middle portion of the composite layer has a volume ratio in the range of 70-90% of the sealant compound and 30% to 10% of the air impermeable compound.

7. The method of claim 1 wherein the dual strip forming the lateral end portions of the composite layer has less than 10% of the sealant compound.

8. The method of claim 1 wherein there are at least two layers of the dual strip forming the middle portion of the composite layer.

9. The method of claim 1 wherein the ratio of the volume of the air impermeable compound to the volume of the sealant compound is varied by changing the ratio of the speed of the first gear pump to the second gear pump.

10. A tire having a composite layer, wherein the composite layer is located radially inward of a layer of ply, wherein the composite layer has a first and second laterally outer end that is formed of a strip of an air impermeable compound, and the composite layer has a middle portion formed of a dual layer strip having a radially inner layer of a sealant compound, and a radially outer layer formed of an air impermeable compound.

11. The tire of claim 10 wherein the dual layer strip is spirally wound.

12. The tire of claim 10 wherein there is no inner liner layer.

13. The tire of claim 10 wherein the dual layer strip forming the middle portion of the composite layer has a volume ratio in the range of 70-90% of the sealant compound and 30% to 10% of the air impermeable compound.

14. The tire of claim 10 wherein the dual layer strip forming the middle portion of the composite layer is formed of two layers of spirally wound dual layer strips.

15. The tire of claim 10 wherein the dual layer strip forming the middle portion of the composite layer is formed of no more than two layers of spirally wound dual layer strips.

16. The tire of claim 10 wherein the middle portion of the composite layer extends from a first shoulder of the tire to a second shoulder of the tire.

17. The tire of claim 10 wherein the thickness of the dual layer strip is in the range of 2 to 10 mm.

18. The tire of claim 10 wherein the axial width of the dual layer strip is in the range of 10 to 50 mm.

19. The tire of claim 10 wherein the thickness of the sealant layer of the dual layer strip is in the range of 3 to 6 mm.

20. The tire of claim 10 wherein the thickness of the air impermeable layer of the dual layer strip is in the range of 0.3 to 2 mm.
